(19) United States
(12) Patent Application Publication
(10) Pub. No.: US 2006/0038401 A1
(43) Pub. Date: Feb. 23, 2006

(54) Coupling for cryogenic media

(75) Inventors: Harald Kleinbeckel, Koeln (DE); Andreas Koepp, Dormagen (DE); Wilfried-Henning Reese, Unterschleissheim (DE); Norbert Ricken, Bochum (DE)

Correspondence Address: CROWELL & MORING LLP;INTELLECTUAL PROPERTY GROUP, P.O. BOX 14300, WASHINGTON, DC, 20044-4300, US

(73) Assignees: Linde Aktiengesellschaft, Wiesbaden (DE); Carl Kurt Walther GmbH & Co. KG, Haan (DE); LINDE AG

(21) Appl. No.: 11/202,072

(22) Filed: Aug. 12, 2005

(30) Foreign Application Priority Data
Aug. 20, 2004 (DE) 10 2004 040 519.0

(51) Int. Cl. F16L 39/00

(52) U.S. Cl. 285/321

(57) ABSTRACT

A coupling for vacuum-insulated pipe or hose lines provided for conducting one or more cryogenic media, in which a single- or multi-core coupler plug and corresponding coupler socket each have a ball valve provided with a through hole and a locking sleeve coupled to rotate its respective ball valve when the sleeve is axially displaced. When the coupler plug and coupler socket are brought together, the locking sleeves engage and are displaced axially, such that the ball valves are moved into open positions in which a conduit of the coupler plug may be extended through the coupler plug ball valve into the coupler socket. Such a coupler allows a docking procedure to be reliably performed in all radial angular positions between the plug side and socket side, without need for skilled operators, position sensor technology or a precision refueling robot.

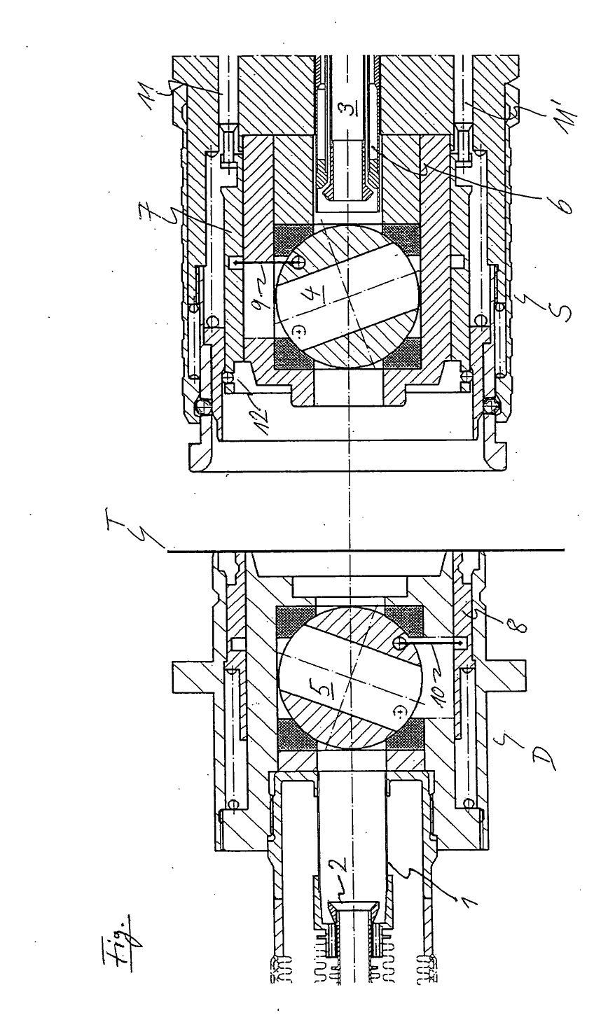

This application claims the priority of German Patent Application No. DE 10 2004 040 519.0, filed Aug. 20, 2004, the disclosure of which is expressly incorporated by reference herein.

### BACKGROUND AND SUMMARY OF THE INVENTION

The invention relates to a coupling for vacuum-insulated pipe or hose lines provided for conducting one or more cryogenic media, and the use of the coupling.

In the following, the letters “G” for “gaseous” and “L” for “liquid” are prefixed or used in the descriptions of specialized cryogenic media according to their physical state; thus, for example, GH₂ and LH₂ stand for gaseous hydrogen and liquid hydrogen, respectively. In addition, the terms “CNG” and “LNG” are used for compressed natural gas and liquefied natural gas, respectively.

Due to increasing demands for energy and heightened environmental consciousness, hydrogen and natural gas in particular have grown in importance in recent times as energy sources. Thus, for example, trucks, buses, automobiles, and locomotives are being operated using engines powered by natural gas or hydrogen, as well as by combinations of fuel cells and electric motors. In addition, initial attempts are underway to operate aircraft using such media.

The storage of hydrogen or natural gas onboard the above-referenced means of transport is most practical in the liquid state. To this end, hydrogen or LNG must be cooled to approximately 25° K or 112° K, respectively, and held at this temperature, which can be achieved only by appropriate insulation measures for the storage containers or tanks. However, because of the low density of GH₂ and CNG, storage in the gaseous state is generally less advantageous in the above-referenced means of transport since the storage must occur in large-volume, heavy storage containers at high pressures.

The above-referenced means of transport, i.e., vehicles, are refueled using generic couplings such as those known from DE-A 41 04 711, for example. The principle of such a coupling is based on a system in which two ball valves, one on the coupler plug side and one on the coupler socket side, are flanged together. A vacuum-insulated filling tube is then led from the plug side through the through holes of the ball valves, and the (cryogenic) medium flows through the filling tube to the coupler socket side. When the filling process is completed, the plug moves back and the ball valves are closed again. The flanging of the ball valves is then separated. Such a refueling coupling allows overfilling of (cryogenic) liquids without cooling of the visible components being discernible on the outside.

In the use of the above-described principle, the ball valves on both the plug side and on the socket side must be opened or closed by rotating the balls. In normal operation heretofore, this actuation procedure has been carried out using a hand lever which—as is customary for the use of ball valves—opens the plug-side ball by means of a 90° rotation. A gearwheel drive which engages upon connection of the coupling halves simultaneously causes the socket-side ball valve to open or close. In the case of so-called robotic applications, as implemented for example in automatic refueling stations, it is possible to actuate the plug-side ball valve by means of a hydraulic and/or pneumatic drive. The socket-side ball valve is thus opened or closed similarly as with hand actuation, via a gearwheel which engages when the coupling flanges are brought together.

A disadvantage of the described method for connecting the ball valve flange, however, is that on account of the geometric conditions the gearwheels must engage before the flange itself makes contact. However, an exact meshing of the gearwheel teeth during the docking or connecting procedure requires a very precise axle guiding with regard to radial deviation and angular offset of the plug-side coupling part relative to the socket-side coupling part. Because of the generally limited space conditions, it is not possible to achieve guiding, for example conical guiding, in the required form. A successful docking procedure, therefore, depends on skill of the operator or on the sensor technology and precise control of the refueling robot.

Furthermore, during the docking procedure the rotational axes of the ball valves must lie in a single plane so that the teeth of the gearwheel drive likewise engage in a single plane. Moreover, during docking it must be ensured that the tooth tip on one side engages with a tooth root on the opposite side. If two tooth tips abut one another it is not possible to connect the flange. In addition, the gearwheels are subjected to heavy soiling from atmospheric influences due to their exposed configuration. Due to the small tolerances in the gearing, soiling can result in jamming of the gearwheels and thus increased wear thereon.

An object of the present invention is to provide a generic coupling for vacuum-insulated tube or hose lines which avoids the above-referenced disadvantages.

This object is achieved by a generic coupling for vacuum-insulated tube or hose lines, characterized in that
the coupler plug and coupler socket each have a locking sleeve that is mounted in an axially displaceable manner,
the locking sleeves engage when the coupler plug and coupler socket are brought together, and
the locking sleeves are connected to the ball valves by sliding pins in such a way that the ball valves are rotated when the locking sleeves are moved from their closed position to their open position, and vice versa.

The terms “open position” and “closed position” are understood to mean the positions of the ball valves in which the conduit of the coupler plug can be inserted (“open position”) or cannot be inserted (“closed position”) into the coupler socket.

In contrast to the known coupling designs, the present coupler plug and coupler socket may be connected to one another without restrictions imposed by exact axis guiding, axis alignment, and meshing of gearwheel pairs.

In a refinement of the coupling according to the invention, it is proposed to position the locking sleeves concentric to the plug-side conduit.

Other objects, advantages and novel features of the present invention will become apparent from the following detailed description of the invention when considered in conjunction with the accompanying drawings.

### BRIEF DESCRIPTION OF THE DRAWINGS

The figure illustrates a cross-sectional view of an embodiment of a coupling in accordance with the present invention.

### DETAILED DESCRIPTION

The figure shows a lateral sectional view of an embodiment of a coupling in the decoupled state, comprising the coupler plug S and the coupler socket D, which are connected to one another at the separating plane T.

The coupler socket D has an outer wall 1 in which the conduit 3 of the coupler plug S—with ball valves 4 and 5 open—is inserted during the refueling process, up to a stop 2. The coupler plug S and coupler socket D each have one ball valve 4 and 5, respectively, in which through holes are provided for accepting the conduit 3 of the coupler plug S. The axially displaceable conduit 3 is situated inside the coupler plug S in a guide tube 6.

The conduit 3 may be displaced by pneumatically, hydraulically, and/or mechanically actuated devices. Generally, insertion of the conduit 3 into the coupler socket D is combined with clamping of the coupler plug S and coupler socket D and opening of the ball valves 4 and 5, thereby simplifying operability of the coupling.

According to the invention, both the coupler plug S and the coupler socket D have a locking sleeve 7 and 8, respectively, which are mounted in an axially displaceable manner. The locking sleeves 7 and 8 engage when the coupler plug S and coupler socket D are brought together.

In a refinement of the coupling according to the invention, it is proposed that the locking sleeves 7 and 8 are connectable via a ball lock 12. The locking sleeves 7 and 8 are forcibly mechanically coupled via the ball lock 12, thus requiring no additional auxiliary energy such as in the form of a spring, for example.

In addition to this ball lock 12, further locking may be achieved by a collet lock or sectional lock, for example.

At least the plug-side locking sleeve 7 is movable or displaceable by means of a pneumatic, hydraulic, and/or mechanical drive, which preferably is an axial drive. In this regard, the drive for the locking sleeve 7 and the drive for the plug-side conduit 3 may be designed as separate units or as a common drive device. After the coupler plug S and coupler socket D are locked together, the plug-side locking sleeve 7 is displaced by the drive rods 11 and 11′, thereby forcibly displacing the socket-side locking sleeve 8 as well.

Since the locking sleeves 7 and 8 are respectively connected to the ball valves 4 and 5 via sliding pins 9 and 10 in such a way that the ball valves 4 and 5 are rotated from their closed position to their open position, and vice versa, displacement of the locking sleeves 7 and 8 in the direction of the coupler socket D causes the ball valves 4 and 5 to open—thus enabling the plug-side conduit 3 to be inserted into the coupler socket D, i.e., the outer wall 1 thereof, up to the stop 2—while displacement of the locking sleeves 7 and 8 in the direction of the coupler plug S (again) closes the ball valves 4 and 5, i.e., rotates them to their closed position. Of course, this rotation of the ball valves 4 and 5 to their closed position cannot occur until the refueling process has ended and the plug-side conduit 3 has been pulled back behind the plug-side ball valve 4.

According to one advantageous embodiment of the coupling according to the invention, the socket-side locking sleeve 8 may have a spring-loaded design such that by elastic energy alone it is moved into a position in which its associated ball valve 5 is in its closed position.

If the above-referenced embodiment of the coupling according to the invention is used without achieving a lock between the locking sleeves 7 and 8 as described above, it is still possible that the socket-side ball valve 5 is not closed when the coupler plug S is decoupled from the coupler socket D, which in the case of refueling of a storage container with a cryogenic medium would result in undesired introduction of heat into the storage container, and, thus, sudden evaporation of the cryogenic medium. Only by achieving a mechanical lock between the locking sleeves 7 and 8 as described above can it be ensured that the socket-side ball valve 5 forcibly closes when the coupler plug S is decoupled.

A coupling according to the invention for vacuum-insulated pipe or hose lines is particularly suited as a refueling coupling for all types of vehicles, especially motor vehicles operated with liquid hydrogen and/or liquefied natural gas, and for which the vehicle-side storage container is refilled with liquid hydrogen or LNG.

A coupling according to the invention thus enables the following advantages, listed by key points:
Only axial motion is required, which can be performed by mechanical, pneumatic, or hydraulic means
Simple and robust design, and therefore long service life
All movable components may be internally installed
Low-noise operation
Soil-resistant, since any contaminants are pushed off by the (slidable) locking sleeves
Excellent operability and reproducibility due to a mechanical connection between the locking sleeves, sliding pins, and ball valves
Rotationally symmetrical design of the components, so that the docking procedure can be reliably performed in all radial angular positions between the plug side and socket side; a successful docking procedure is therefore independent of skill of the operator or the sensor technology and precise control of the refueling robot
Suitable for operation in series

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A coupling for vacuum-insulated pipe or hose lines for conducting one or more cryogenic media, comprising:
a single- or multi-core cryogenic media coupler plug; and
a corresponding coupler socket arranged to be coupled to the coupler plug,
wherein
in the coupled state a conduit of the coupler plug is movable in an axial direction relative to the coupler plug to extend into the coupler socket;
the coupler plug and coupler socket each have a ball valve provided with a through hole through which the conduit is passable,
the coupler plug and coupler socket each have an axially displaceable locking sleeve, each sleeve being coupled to rotate its respective ball valve,
the locking sleeves are arranged to engage one another when the coupler plug and coupler socket are brought together, such that the locking sleeves are axially displaced from closed positions to open positions, and the ball valves are rotated between respective closed and open positions.

2. A coupling according to claim 1, wherein the locking sleeves are positioned concentric to the plug-side conduit.

3. A coupling according to claim 1, wherein at least the plug-side locking sleeve is displaceable by at least one of a pneumatic, hydraulic, and mechanical drive.

4. A coupling according to claim 2, wherein at least the plug-side locking sleeve is displaceable by at least one of a pneumatic, hydraulic, and mechanical drive.

5. A coupling according to claim 3, wherein the plug-side locking sleeve and the socket-side conduit locking sleeve are driven by one of separate drives and a common drive.

6. A coupling according to claim 4, wherein the plug-side locking sleeve and the socket-side conduit locking sleeve are driven by one of separate drives and a common drive.

7. A coupling according to claim 1, wherein the socket-side locking sleeve is biased to move toward the closed position.

8. A coupling according to claim 1, wherein the locking sleeves are connectable by at least one of a collet lock, a sectional lock, and a ball lock.

9. A method for coupling vacuum-insulated pipe or hose lines for conducting one or more cryogenic media, comprising the acts of:
providing a coupling, the coupling comprising a single- or multi-core cryogenic media coupler plug and a coupler socket arranged to be coupled to the coupler plug, wherein in the coupled state a conduit of the coupler plug is movable in an axial direction relative to the coupler plug to extend into the coupler socket, the coupler plug and coupler socket each have a ball valve provided with a through hole through which the conduit is passable, the coupler plug and coupler socket each have an axially displaceable locking sleeve, each sleeve being coupled to rotate its respective ball valve, and the locking sleeves are arranged to engage one another when the coupler plug and coupler socket are brought together, such that the locking sleeves are axially displaced from closed positions to open positions and the ball valves are rotated between respective closed and open positions;
coupling the coupling plug to the coupling socket; and
extending the conduit through the coupling plug ball valve and through the coupling socket ball valve.

10. The method for coupling vacuum-insulated pipe or hose lines according to claim 9, wherein the act of extending the conduit through the coupling plug ball valve and through the coupling socket ball valve includes extending the conduit until a socket-side end of the conduit engages a corresponding conduit receiving seat after passing through the coupling socket ball valve.
